(19) United States
(12) Patent Application Publication
(10) Pub. No.: US 2007/0139317 A1
(43) Pub. Date: Jun. 21, 2007

(54) LED electric circuit assembly

(75) Inventors: Alain Martel, Sainte-Adele (CA); Daniel Chevalier, Boisbriand (CA)

Correspondence Address: Ronald S. Kosie;BCF LLP, 25th Floor, 1100 Rene-Levesque Boulevard West, Montreal, QC, H3B 5C9, CA

(73) Assignee: DELLUX TECHNOLOGIES INC.

(21) Appl. No.: 11/399,465

(22) Filed: Apr. 7, 2006

(30) Foreign Application Priority Data
Dec. 16, 2005 (CA) 2,530,661

(51) Int. Cl. G09G 3/32

(52) U.S. Cl. 345/82

(57) ABSTRACT

A luminaire comprising an electric circuit element for a lighting system. The electric circuit element comprises an LED electric circuit assembly. The LED electric circuit assembly comprises one or more current regulated LED strings or chains. Each of the LED strings or chains comprises a respective current regulator and one or more LEDs linked in series with a respective current regulator. The LED electric circuit assembly is configured such that when the LED electric circuit assembly comprises two or more LED strings or chains, the two or more LED strings or chains are linked in parallel.

The present invention relates to lighting systems (e.g. lighting devices) which exploit one or more light emitting source elements. The present invention in particular relates to lighting systems (e.g. lighting devices) which exploit one or more light emitting diodes (herein sometimes simply referred to as LED (i.e. for one such light emitting diode) or LEDs (i.e. for two or more such light emitting diodes)). The present invention will be discussed hereinafter with particular attention to the use of LED electric circuit assemblies exploiting light emitting strings or chains and faced with the problem of constant current operation.

The present invention thus for example relates to an LED lighting system (e.g. an LED lighting device, e.g. luminaire) which may comprise one or more LED strings or chains; an LED string or chain may comprise a string or chain of LEDs linked in series. An LED lighting system may take the form of an LED lighting device which may for example take the form of a single distinct LED lamp or luminaire which may comprise one or more LED strings or chains; a LED lighting system may alternatively for example comprise a plurality of LED lamps or luminaires.

LED lighting systems (e.g. lighting devices) are known which are composed of an LED array containing a large number of LEDs (please see for example published U.S. patent application no. 20050122064, the entire contents of which are incorporated herein by reference) . It is known that it is advantageous to drive (i.e. energize) LEDs with a constant current source, i.e. connecting the LED array to an electrical power source able to provide a constant current flow through the LED array. It is for example known to exploit a power source which is a current-regulated power supply adjusting the power supply output voltage so that output current matches a specific, predetermined target current; variations of this type of system are for example described in U.S. Pat. Nos. 6,577,512 and 6,285,139, the entire contents of which are incorporated herein by reference. However, when multiple LED strings are used, the current flowing through each LED string or chain may not be the same or uniform; some LED strings may receive a higher current than others which may lead to uneven light output and uneven aging of the LED strings or chains.

It would be advantageous to have a means, a system and/or method to adjust (e.g. calibrate or optimize) the electrical power efficiency of a power supply which supplies electrical power to a current-regulated load. It in particular would be advantageous to be able to adjust (e.g. improve) the electrical power efficiency of new or existing lighting systems (e.g. lighting devices) which for example exploit LEDs (Light Emitting Diodes) as a source of light.

It would be advantageous to have a voltage self-calibrating, self (re)setting or self stabilizing power supply system for lighting systems (e.g. lighting devices) and in particular LED based lighting systems (e.g. lighting devices).

It would be advantageous to have a means, system, method etc., whereby it is possible to adjust the electrical power efficiency of a lighting system (e.g. lighting device) which it is desired to operate under essentially constant current conditions. It would be advantageous to be able to operate a lighting system (e.g. lighting device) at a lower voltage than a lighting system (e.g. lighting device) not equipped with this constant current feature, while drawing the essentially the same current and providing essentially the same light output.

It would be advantageous to have a means to allow for a reduction in the size of a thermal dissipation system (heatsink) of a lighting system (e.g. lighting device), i.e. in the case where less heat is generated internally; in a LED lighting system (e.g. LED lighting device), thermal management is a factor to consider in the construction thereof.

It would be advantageous to have a means for facilitating the manufacturing process of a lighting system (e.g. lighting device); for example, it would be advantageous to have a means whereby a standard light unit may be built to accommodate various types and batches of LEDs, which would otherwise require design modifications in each case depending on the junction voltage of each batch.

The present invention in accordance with one aspect relates to an LED electric circuit assembly comprising one or more LED strings or chains and wherein each of said LED strings or chains comprises a current regulator and one or more LEDs linked in series with said current regulator, said LED electric circuit assembly being configured such that when said LED electric circuit assembly comprises two or more LED strings or chains, said two or more LED strings or chains are linked in parallel,. In accordance with the present invention an electric circuit element may comprise such a current regulated LED electric circuit assembly, i.e. a luminaire (e.g. a single lighting device such as a lamp) may comprise such an electric circuit element.

In accordance with the present invention an electric circuit element comprising a LED electric circuit assembly may be linked to a voltage controllable power supply element for energizing the LED electric circuit assembly, said power supply element being configured to provide a set voltage across the electric circuit element, said set voltage being variable in response to a voltage control signal.

In accordance with the present invention an electric circuit element comprising a LED electric circuit assembly as discussed herein may further comprises an electrical power component sensor means, said electrical power component sensor means being configured to generate a power component signal indicative of an electrical power component supplied to said electric circuit element by a voltage controllable power supply element. The electric power component may be an electric current (I) or an electric voltage (V); i.e. given that the electric power equation may be expressed as P(ower)=current (I)×electric voltage (V).

In accordance with the present invention a power component signal may be indicative of an electric current. In this case an electric circuit element may comprise a current sensor, wherein said current sensor is linked in series with said LED circuit assembly, and wherein the current sensor is configured to generate said signal indicative of an electric current.

In accordance with the present invention a power component signal may be indicative of an electric voltage. In this case an electric circuit element may comprise a voltage sensor, wherein said voltage sensor is linked in parallel with said current regulator, and wherein the voltage sensor is configured to generate said signal indicative of a voltage.

In accordance with the present invention an electric circuit element comprising a LED electric circuit assembly may be linked to a voltage control element. Thus, in accordance with the present invention a power component signal may be delivered in any suitable manner to a voltage control element having an input for receiving a power component signal indicative of an electrical power component supplied to the electric circuit element by a voltage controllable power supply element; the voltage control element being configured (in any suitable or desired fashion) to generate, in response to said power component signal, a voltage control signal for delivery to said controllable power supply element.

The present invention in accordance with another aspect relates to a system for manipulating (e.g. calibrating, such as for example optimizing) the electrical power or energy provided by a power supply to an electric circuit element which may comprise an LED electric circuit assembly.

Thus the present invention provides an electric power system for manipulating the electrical power or energy provided by a power supply to an electric circuit element for a lighting system, said electric circuit element comprising an LED electrical circuit assembly, said LED electric circuit assembly comprising one or more LED strings or chains, and wherein each of said LED strings or chains comprises a current regulator and one or more LEDs linked in series with said current regulator, said LED electric circuit assembly being configured such that when said LED electric circuit assembly comprises two or more LED strings or chains, said two or more LED strings or chains are linked in parallel,

said electric power system comprising:
a voltage controllable power supply element for energizing said LED electric circuit assembly, said power supply being configured to provide a set voltage across said electric circuit element, said set voltage being variable in response to a voltage control signal,
and
a voltage control element having an input for receiving a power component signal indicative of an electrical power component supplied to said electric circuit element by said voltage controllable power supply element, and said voltage control element being configured to generate, in response to said power component signal, a voltage control signal for delivery to said controllable power supply element.

In accordance with the present invention an electric power system may be configured to supply power to a single LED electrical circuit assembly (e.g. to a single luminaire as described herein) or to a plurality of LED electric circuit assemblies (e.g. a plurality of luminaries as described herein).

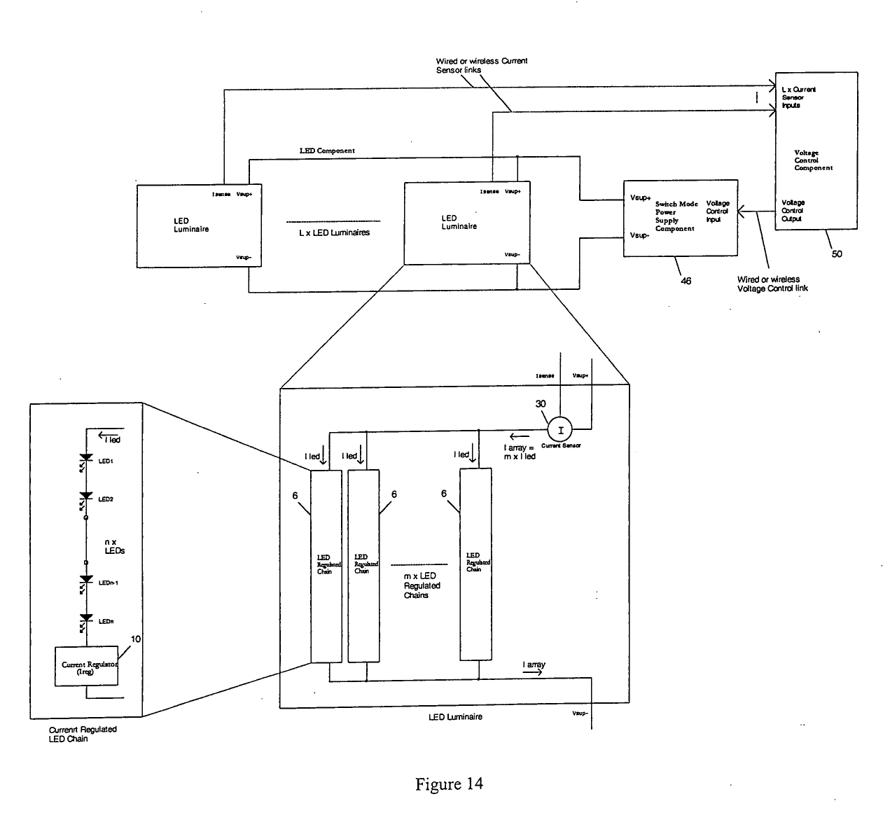

In accordance with the present invention a voltage controllable power supply element and/or a voltage control element may form part of a luminaire or be disposed remote therefrom while being electrically connected thereto in any suitable manner; thus while a power supply element may be linked to a luminaire(s) by wire connection, a voltage control element may be linked to the power supply element and/or a power component sensor means by wire or by wireless type connections (i.e. wireless communications may of course be of an analogue or digital type). A wireless linkage may take on any desired (e.g. known) configuration keeping in mind the purpose thereof, namely to pass signals between elements (see for example FIG. 14 below).

Thus, for example, in accordance with the present invention, a luminaire may further comprise a voltage controllable power supply element for energizing a LED electric circuit assembly, said power supply element being configured to provide a set voltage across the electric circuit element thereof, said set voltage being variable in response to a voltage control signal. A luminaire as described herein may also further comprise or be remotely connected (e.g. wirelessly) to a voltage control element as described herein having an input for receiving a power component signal indicative of an electrical power component supplied to the electric circuit element by said voltage controllable power supply element.

In accordance with the present invention a voltage control element may take on any desired or necessary form keeping in mind that it is to be configured in any suitable desired manner to generate, in response to said power component signal, a voltage control signal for delivery to said controllable power supply element. Thus a voltage control element may comprise a suitably programmed computer device having appropriate input and output means for receiving and sending the signals mentioned herein. The computer device may for example comprise a suitable program able to evaluate or manipulate a power component signal, compare signals with predetermined electrical values such as for example a predetermined voltage, a predetermined current to voltage ratio, etc. as well as generate a voltage signal(s) for delivery to the power supply either by wire or by a wireless type link (e.g. to determine a voltage control signal in an iterative type manner). The voltage control element may in particular generate desired voltage control signals in response to a signal indicative of current.

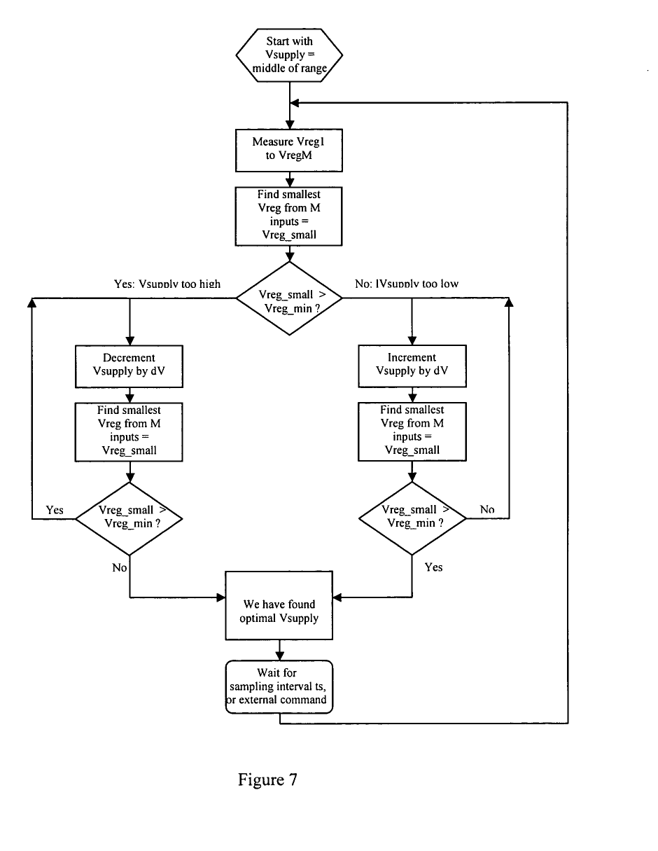

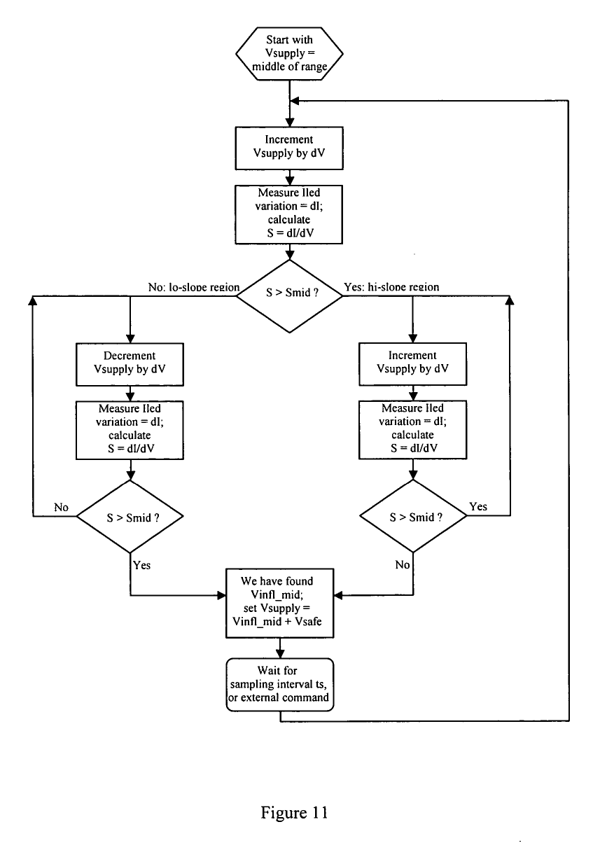

Thus the present invention in accordance with a further aspect provides a lighting system comprising:
a voltage control component,
an LED component, and
a voltage controllable power supply component for energizing said LED component,
   1. wherein said LED component comprises one or more luminaries,
   2. wherein each of said luminaires comprises a respective electric circuit element and a respective current sensor,
   3. wherein each of said respective electric circuit elements comprises a respective LED electric circuit assembly
   4. wherein each of said respective LED electric circuit assemblies comprises one or more current regulated LED strings or chains, each of said LED strings or chains comprising a respective current regulator and one or more LEDs linked in series with said respective current regulator, and each of said respective LED electric circuit assemblies being configured such that when a respective LED electric circuit assembly comprises two or more LED strings or chains, said two or more LED strings or chains are linked in parallel,
   5. wherein each of said respective current sensors is linked in series to a respective LED electric circuit assembly, each of said respective current sensors being configured to generate a respective current signal indicative of the current supplied to a respective LED electric circuit assembly,
   6. wherein said voltage controllable power supply component is configured to provide a set voltage across each of said electric circuit elements, said set voltage being variable in response to a respective voltage control signal, and
   7. wherein said voltage control component having an input for receiving each of said respective current signals provided from said respective current sensor elements, said voltage control component being configured to generate said respective voltage control signals in response to said respective current signals for delivery to said controllable power supply component.
In accordance with the present invention a lighting device or system as mentioned above may comprise a current sensor element. In this case the voltage control element or system may be configured to follow an iterative approach (i.e. iterative method) for the determination of the desired or necessary voltage of the power supply (see FIG. 11). For this approach the control system may generate an initial voltage control signal for delivery to said controllable power supply component for inducing said power supply to make a predetermined incremental/decremental voltage change in the supplied voltage. The change in voltage will produce a change in the current signal delivered from the current sensor to the voltage control element. The voltage control element may be configured to calculate the change in current based on the received current signal and a current signal value already stored in the computer. The computer may be configured to divide the obtained current change by the induced change in voltage to determine the ratio of said change in current to said predetermined incremental change in voltage to obtain a detected current to voltage ratio and compare said detected current to voltage ratio with a desired predetermined current to voltage ratio (e,g see “Smid” below—FIG. 11). When said detected current to voltage ratio is less than said predetermined current to voltage ratio, the computer may be configured to repeat the process until such detected current to voltage ratio is not less than said predetermined current to voltage ratio, i.e. repeatedly produce a voltage signal for inducing said power supply to make a predetermined decremental change in the voltage followed after each decremental voltage change by a comparison of the above described detected current to voltage ratio with the predetermined current to voltage ratio. Alternatively, when said detected current to voltage ratio is greater than said predetermined current to voltage ratio, the computer may be configured to repeat the process until such detected current to voltage ratio is not greater than said predetermined current to voltage ratio, i.e. repeatedly produce a voltage signal for inducing said power supply to make a predetermined incremental change in the voltage followed after each incremental voltage change by a comparison of the above described detected current to voltage ratio with the predetermined current to voltage ratio. In any case once the detected current to voltage ratio has achieved an acceptable value, the computer may be configured to leave the power supply to provide the voltage as set by the last voltage signal or if desired be configured to send a further last voltage control signal to induce the power supply to adjust the voltage a further amount (e.g. to adjust the voltage upwardly a desired amount). This iterative procedure is described below in relation to a logic block diagram. The computer may be configured to repeat the process after a desired or predetermined interval has elapsed. Although the iterative approach (i.e. iterative method) has been described above in relation to a power component signal which is indicative of current, an iterative approach (i.e. iterative method) may also be applied in relation to a power component signal which is indicative of voltage (see FIG. 7).

In drawings which illustrate example embodiments of the invention,

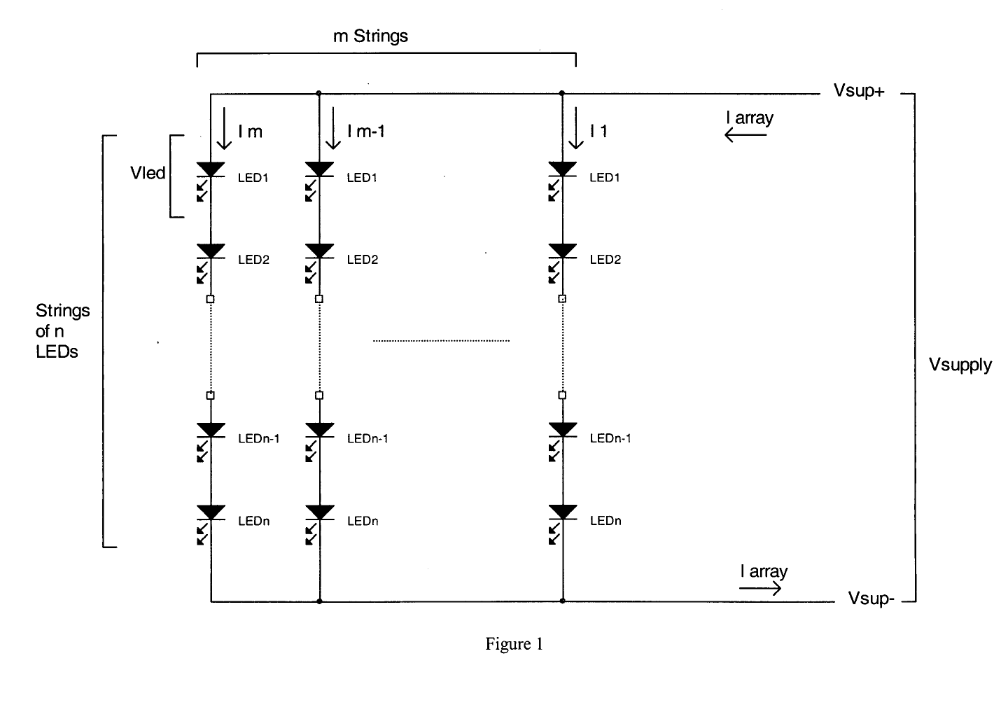

FIG. 1 illustrates a Prior art LED array for an LED Lighting system;

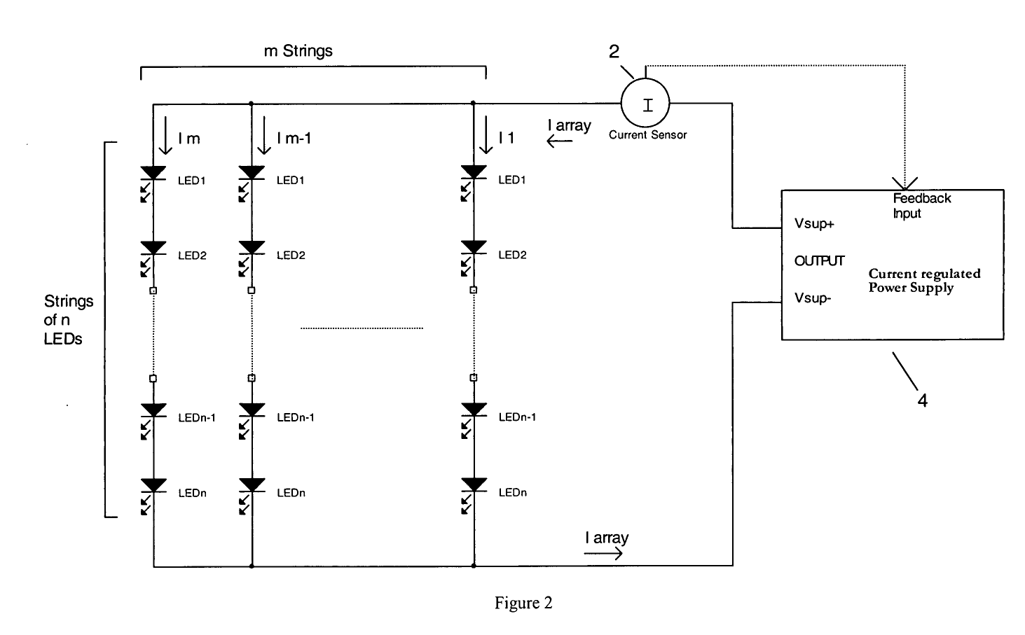

FIG. 2 illustrates a Prior art LED lighting system comprising an LED array shown in FIG. 1 and an associated current regulated power supply;

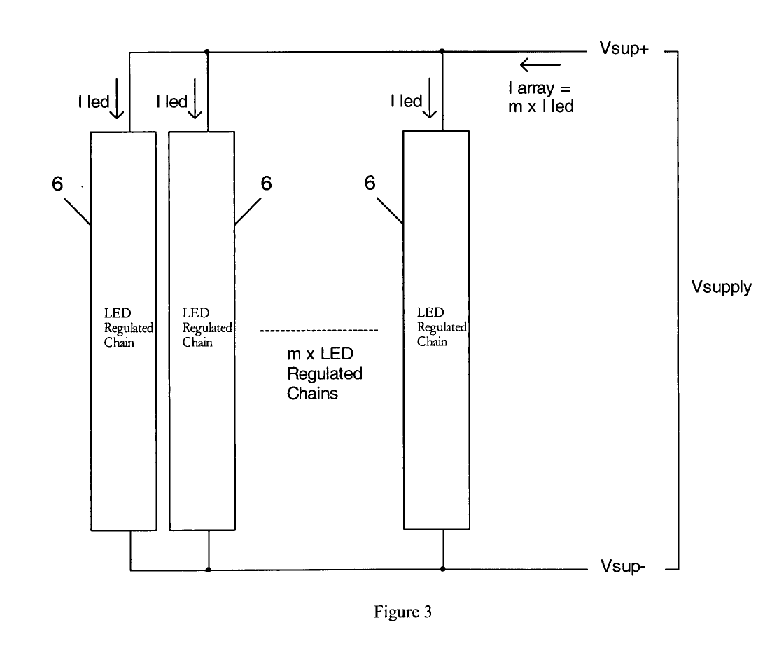

FIG. 3 illustrates an example embodiment of an LED electric circuit assembly in accordance with the present invention comprising a plurality of individually current-regulated LED strings or chains;

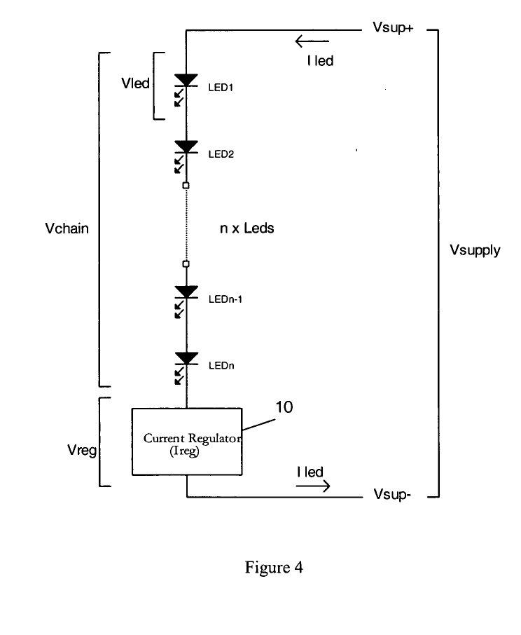

FIG. 4 illustrates an example embodiment of a single current Regulated LED string or chain which may be exploited in the LED electric circuit assembly shown in FIG. 3;

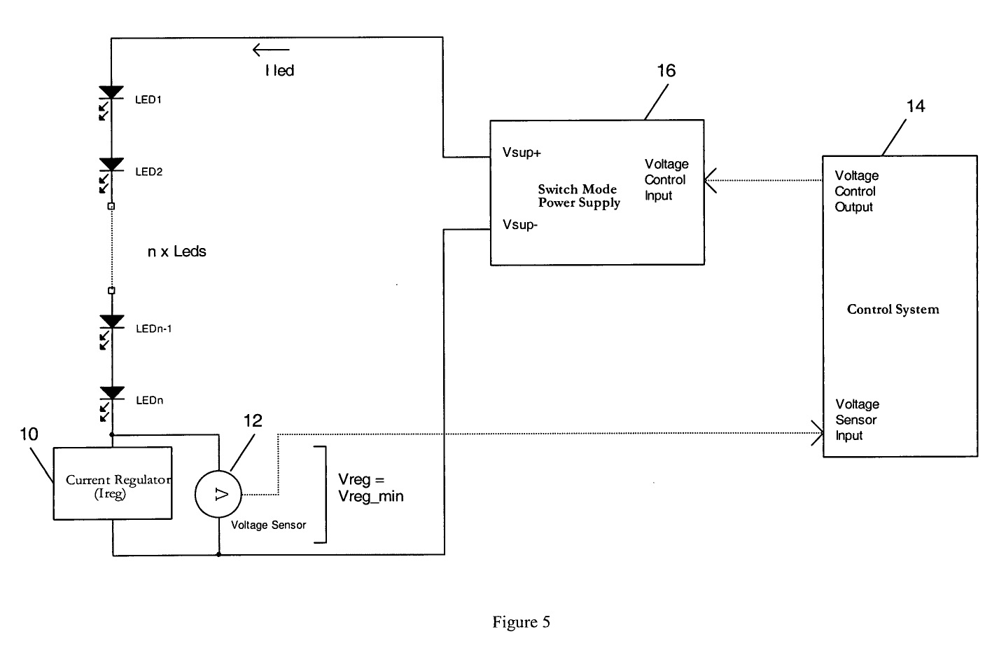

FIG. 5 illustrates an example embodiment of a lighting system in accordance with the present invention comprising a single current Regulated LED string or chain as shown in FIG. 4 associated with an electric power system in accordance with the present invention wherein the voltage of the power supply is variable in response to a signal from a voltage sensor associated with the current regulator;

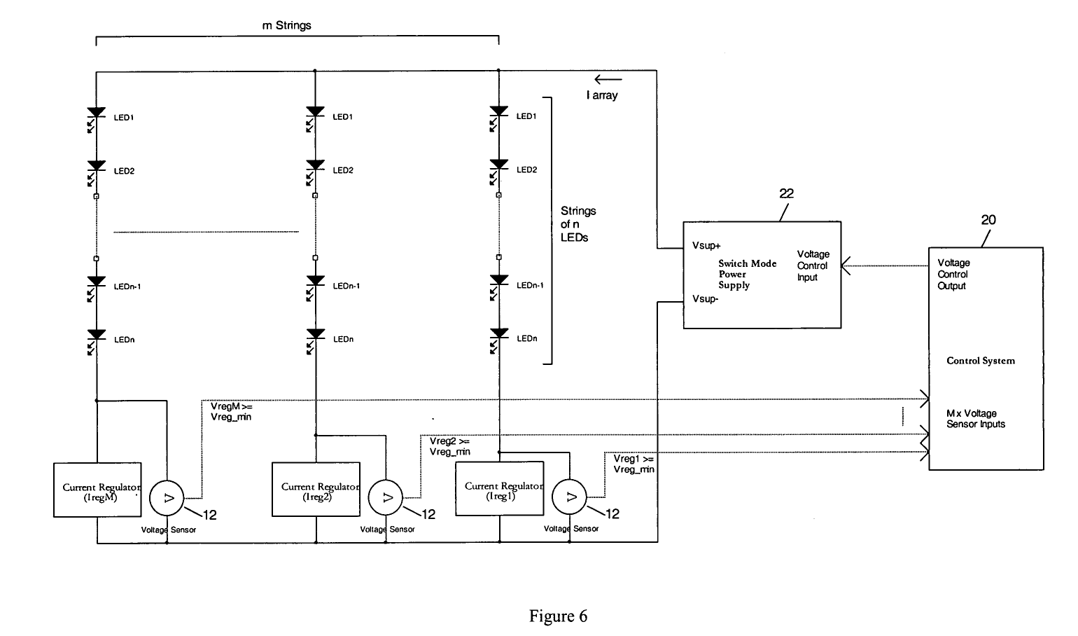

FIG. 6 illustrates an example embodiment of a lighting system in accordance with the present invention comprising a plurality of current Regulated LED strings or chains (such as shown in FIG. 4) associated with an electric power system in accordance with the present invention wherein the voltage of the power supply is variable in response to signals from voltage sensors associated with respective current regulators;

FIG. 7 illustrates an example embodiment of a Voltage-sensing Control System flowchart setting forth the logic steps for a voltage sensing (self-calibration) iterative type control loop;

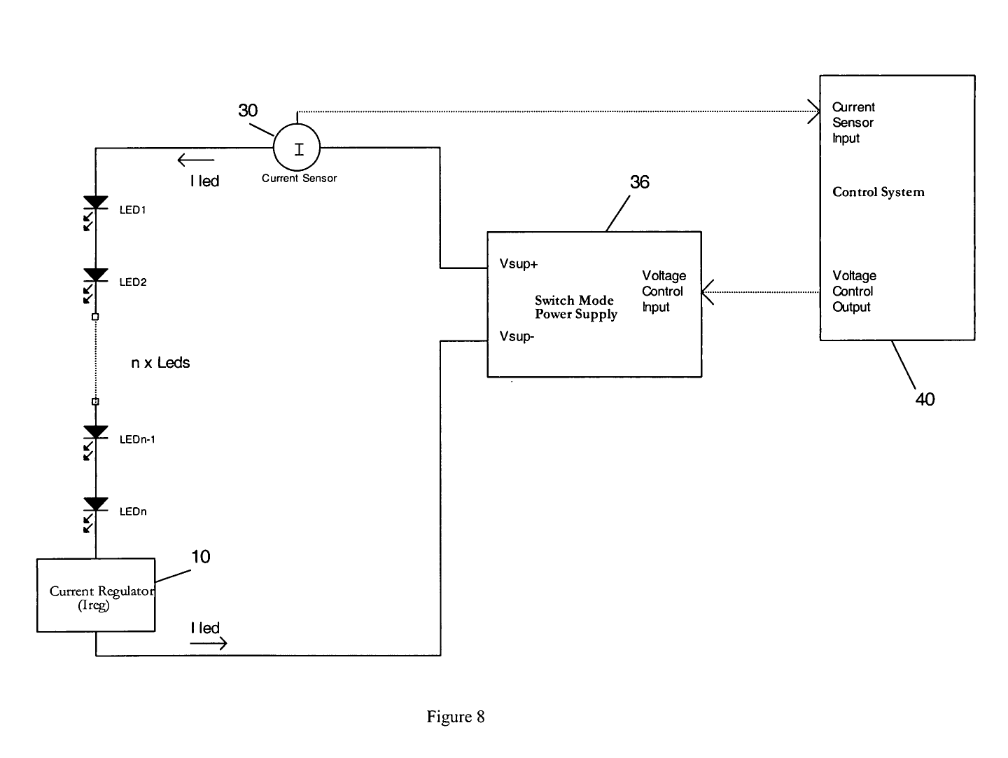

FIG. 8 illustrates another example embodiment of a lighting system in accordance with the present invention comprising a single current Regulated LED string or chain as shown in FIG. 4 associated with an electric power system in accordance with the present invention wherein the voltage of the power supply is variable in response to a signal from a current sensor linked in series with the LED string or chain;

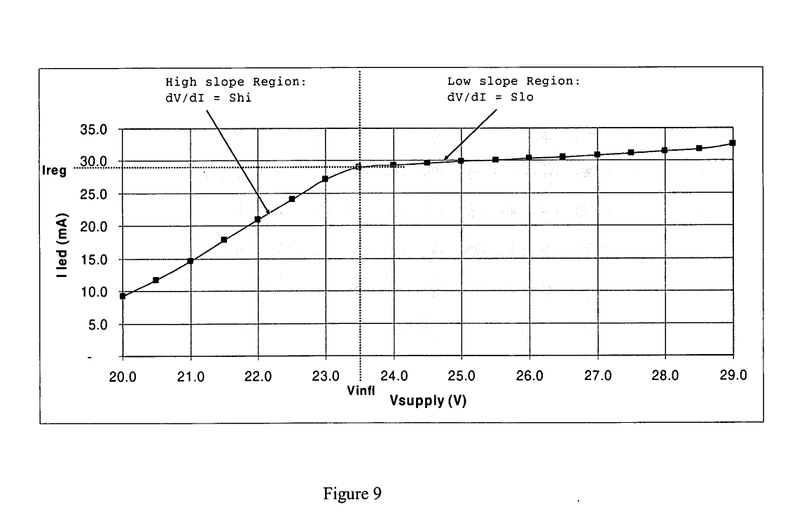

FIG. 9 illustrates an example graph of typical LED chain current behavior;

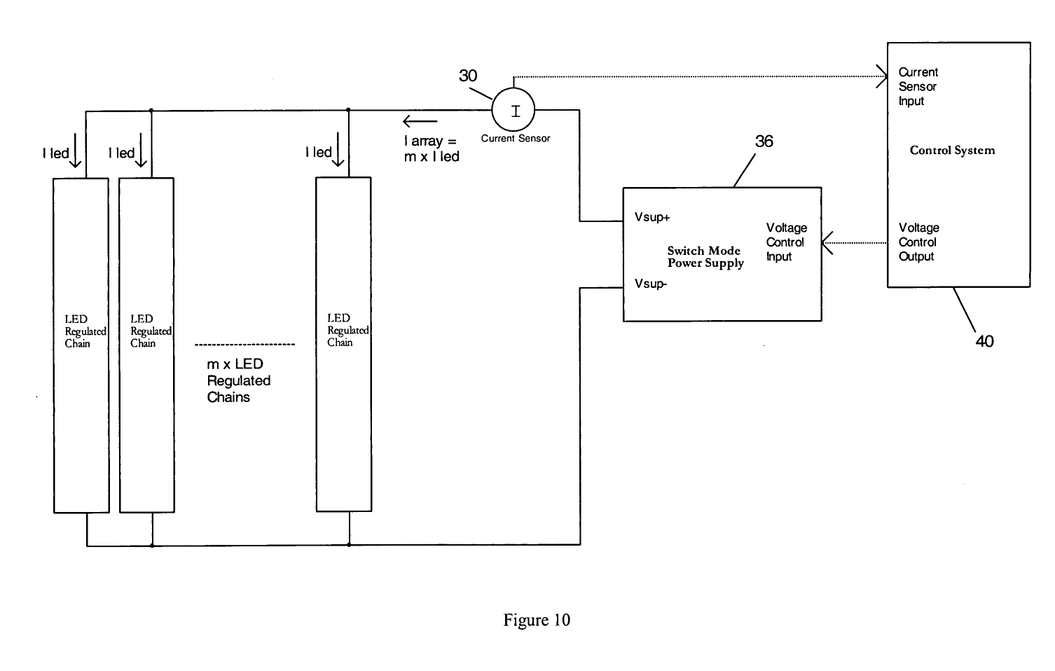

FIG. 10 illustrates another example embodiment of a lighting system in accordance with the present invention comprising a plurality of current Regulated LED strings or chains (such as shown in FIG. 4) associated with an electric power system in accordance with the present invention wherein the voltage of the power supply is variable in response to a signal from a current sensor linked in series with the plurality of LED strings or chains;

FIG. 11 illustrates an example embodiment of a Current-sensing Control System flowchart setting forth the logic steps for a current sensing (self-calibration) iterative type control loop for an “iterative slope sampling” algorithm;

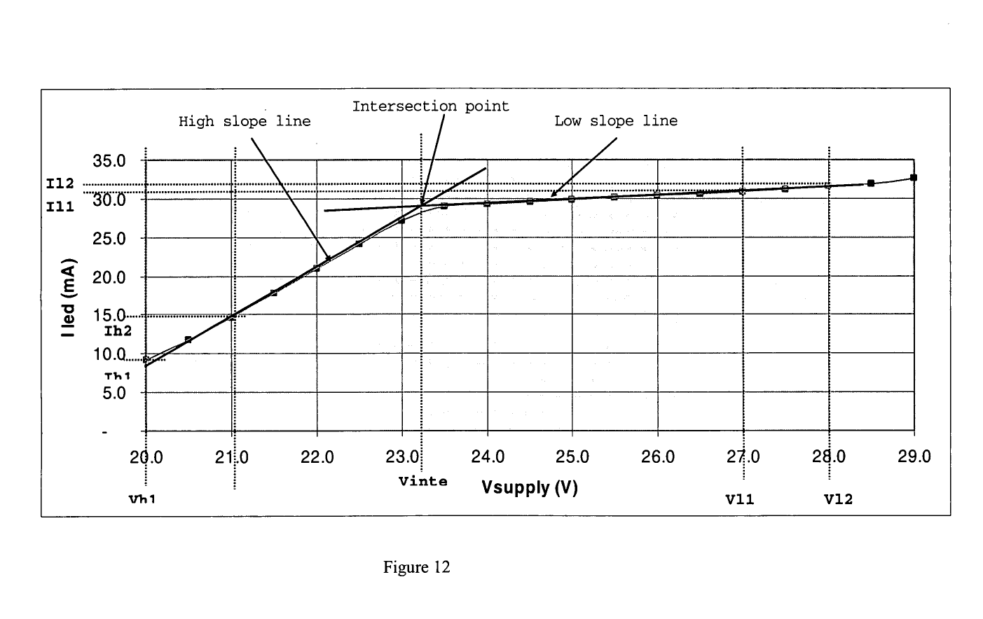

FIG. 12 illustrates an example graph of typical LED chain current behavior showing the determination of chain current behavior for a power control methodology exploiting “Direct Intersection” of the high and low slopes;

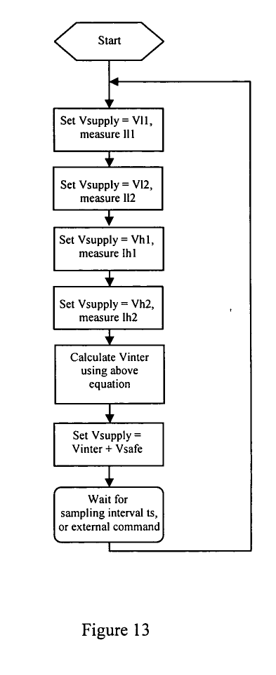

FIG. 13 illustrates an example embodiment of a Current-sensing Control System flowchart setting forth the logic steps for a current sensing (self-calibration) iterative type control loop for a “Direct Intersection” algorithm; and

FIG. 14 illustrates an example embodiment of a Lighting System in accordance with the present invention comprising a plurality of LED luminaries in accordance with the present invention with ( self-calibrating) voltage control being responsive to signals from current sensors.

In the following the same reference numeral will be used t designate the same element in the various figures.

In the following I refers to current, V to voltage, P to power; e.g. Iarray refers to the array current, Vsupply refers to supply voltage, Pchain refers to power dissipated by a chain and so on and so forth.

Referring to FIG. 1, this Figure illustrates a typical known LED Lighting component made with an LED array containing a large number of LEDs. This LED array consists of a quantity “m” of parallel-connected LED strings or chains (wherein m is an integer of 1 or more (e.g. m=10)), each LED string or chain as shown is made of a quantity “n” LEDs linked together in series (wherein n is an integer of 1 or more (e.g. n=10)). Thus in FIG. 1 the LEDs of a string or chain are identified as LED 1, LED 2 . . . LEDn-1 and LEDn. In the following unless indicated otherwise m and n will be used in the same way to respectively identify the number of LED strings or chains and the number of LEDs in a string or chain.

The LED array of FIG. 1 may be powered by a power source providing a supply voltage “Vsupply”, which generates a current “Iarray” flowing across the LED array. Because LEDs have a non-linear relation between their junction voltage “Vled” and junction current, it is known that it is advantageous to energize or drive the LEDs by supplying them with power from a constant current source. Therefore a known LED Lighting system may have a structure of the type shown in FIG. 2 comprising the LED array of FIG. 1, and a power source, the power source comprising a current sensor 2 and a power supply element generally designated by the reference numeral 4:

In the system shown in FIG. 2, the power source is a current-regulated power supply consisting of the following elements:

A current sensor 2 measuring the total LED array current “Iarray”; and

A power supply element 4 e.g. (switch-mode or linear) providing an output voltage “Vsup”, the power supply element 4 comprising a feedback mechanism adjusting the power supply output voltage so that output current matches a specific, regulated target current (i.e. predetermined current).

Variations of this known type of systems are described in for example in U.S. Pat. No. 6,285,139.

In practice the system shown in FIG. 2 works well for an LED array having only a single LED string or chain (i.e. where M=1), since the current “Iarray” flowing through a single LED string or chain is precisely regulated by the power supply. However when multiple LED strings or chains are used, a new problem appears. Since there are inevitably variations in the junction voltages across each LED string, the current flowing through each LED string will not be uniform (i.e. the currents I₁ thru Iₘ may not be the same): some LED strings will receive higher current than others. This leads to various drawbacks, such as uneven light output and uneven aging of the LED strings. Minimizing these differences require a precision matching of all LEDs in the array, which is almost impossible and expensive to achieve.

It has been determined in accordance with an aspect of the present invention that an advantageous solution to this problem consists of using an LED electric circuit assembly (see FIG. 3) comprising an array of LED strings or chains wherein each LED string or chain includes a respective individual Current Regulator connected in series with the LEDs of the respective LED string or chain; for the example assembly as shown in FIG. 3, each current regulated LED string or chain is identified by the general reference numeral 6).

Each of the parallel LED strings or chains 6 draws a regulated current “Iled”, for a total array current (Iarray) which equals “m×Iled”, the current being supplied by a DC power supply providing “Vsupply”; (wherein m is the number of LED strings or chains in the assembly and as mentioned above m is an integer of 1 or more (e.g. m=10)).

Referring to FIG. 4, this figure shows in more detail, the structure of each current-regulated LED string or chain; the LEDs in the chain being identified as mention above in relation to the number of LEDs which number is identified as n. Although in FIG. 4, the current regulator 10 is shown as being connected to an end of the string of LEDs, the current regulator, as long as the linkage is in series, may be disposed elsewhere in the LED chain, e,g, LEDs may be disposed on either side of the current regulator.

For an LED string or chain as shown in FIG. 4:
Each LED in the string chain has a junction forward voltage drop “Vled”, for a total drop “Vchain” : wherein Vchain=n×Vled
In order to ensure a stable light output under varying Vled, a Current Regulator circuit limits the current across the LED string or chain to a fixed target value “Ireg” (typically 20-30 mA). The voltage drop developed across the Current Regulator is “Vreg” such that:
   Vreg+Vchain=Vsupply 1.
A typical Current Regulator requires a minimum voltage drop in order to reach its specified current limit (typically Vreg_min=1 Volt).
Current Regulators of this type are commonly available in inexpensive integrated circuits containing groups of up to 8 or 16 regulators per IC, made by IC manufacturers such as Toshiba (e.g. TB62705), Allegro (e.g. A6275) and Texas Instruments (e.g. TLC5921).

Efficiently powering a single LED string or chain as shown in FIG. 4 (wherein m=1) or the LED array shown in FIG. 3 (wherein m=2 or more) poses new challenges not addressed by the type of current-regulated power supply of shown in FIG. 2. This is because the current regulators in each of the LED Regulated strings or Chains of the example LED assembly of the invention as shown in FIG. 3 interfere with the simple type of current-regulation feedback shown in FIG. 2 based on the global current “Iarray”.

It may be possible to take as an approach the setting of the power supply target regulation current “Itarget” to m×Iled; however due to the non-linear nature of the voltage/current behavior of a current regulated LED string or chain as shown, any slight mismatch between m×Iled and Itarget can lead the current-regulated power supply to stabilize at a wastefully high voltage if Itarget is above m×Iled by even a slight proportion; such a mismatch is in practice unavoidable, since the inexpensive Current Regulators used in each LED chain have a typical 5 to 10% uncertainty margin in their current limit. Iled can also exhibit different temperature dependence than Itarget, leading to further temperature-related mismatches.

Since driving an LED electric circuit assembly as shown in FIG. 3 through a current-regulated power supply may not be as efficient as may be desired, another approach may be to drive the LED electric circuit assembly through a constant voltage power supply, i.e. use a power supply configured to provide a (essentially) set voltage to the LED array or assembly. The difficulty in optimizing the power efficiency of this system lies in properly estimating the supply voltage Vsupply, which in turn depends on Vled.

In practice many factors may lead to variations in Vled:
Variations in the LED junction material lead to wide variations in Vled even for an identical LED model. For example a typical hi-brightness Amber LED is specified with a junction forward voltage Vled between 1.7 and 2.6V. Binning by Vled is possible (at a higher cost), but even then typical Vled variations within a single bin can be of the order of 10%.
Vled is sensitive to junction current. For example a typical hi-brightness Amber LED has Vled varying between 1.9V and 2.2V within a junction current range of 10 mA to 30 mA.
Vled is sensitive to temperature. For example a typical hi-brightness Blue LED has Vled varying between 4.2V and 3.4V within a temperature range of −25° C. to 50° C.

In designing an LED lighting system with this approach (i.e. using a power supply delivering a set voltage), one must take into account that under all expected variations in Vled (and consequently Vchain), Vsupply should always be high enough to maintain the required minimum voltage Vreg_min across the Current Regulator:
Vsupply>Vchain_max+Vreg_min

For example: in a typical LED lighting device or system using a chain of 10 Amber LEDs, Vchain can vary between 18V and 26V, with an average value of 22V. Therefore to cover all cases, we must design:
Vsupply=Vchain_max+Vreg_min=26V+1V=27V

Whereas the Vsupply actually needed by the average LED chain would be:
Vsupply_{—}av=22V+1V=23V

For this average LED chain, the extra 27V-23V=4V has to be absorbed by the Current Regulator, which essentially dissipates it in heat.

The overall power dissipation of the LED chain is calculated as (assuming a 20 mA LED current):
Pchain=Vsupply×Iled=27V×0.020 A=0.54 W

Since the average LED chain would only require:
Pchain_{—}av=Vsupply_{—}av×Iled=23V×0.020 A=0.46 W,

this corresponds to a waste of about 15% in power.

Accordingly, in accordance with another aspect of the present invention the present invention relates to a means to manipulate (e.g. calibrate, such as for example optimize) the power supply of a current-regulated load having an optimal load voltage and current which may both be unknown, and dynamically variable under conditions such as time and temperature. A typical example of such a load is a LED array in a LED Lighting device or system such as shown in FIGS. 3-4, where the component “Vchain” of the load voltage is variable.

The present invention in particular proposes means able to reduce the amount of wasted power in the current-regulated load by dynamically adjusting Vsupply so that it tracks the actually required Vchain. In accordance with the present invention:

The LED array or assembly of the present invention (e.g. of a lighting system, e.g. of lighting device) may be associated with a Power Supply able to provide a set voltage but having a voltage output which is controllable. This voltage control can be exercised either analogically (e.g. through a Voltage-controlled input), or digitally (e.g. through a serial link); the exact nature of the control may take on any desired or necessary configuration keeping in mind the function thereof.

The LED array or assembly of the present invention (e.g. of a lighting system, e.g. of lighting device) may be associated with a Control System which measures the behavior of the LED array or assembly through a power component (e.g. current or voltage) Sensor input, and which is configured as desired or necessary in order to adjust the Power Supply voltage through a Control output sent to the power supply so that Vsupply is just high enough to maintain the specified LED current “Ireg” across the LED chain. This Control System may for example be microcontroller-based.

Advantageously, the Power Supply may be configured so as to be able to maintain constant power efficiency independently of the Vsupply setting; otherwise the power reduction in the LED chain may be offset by an equivalent power waste in the Power Supply itself. This characteristic may be met by the use of a modern Switch Mode Power Supplies (SMPS).

A Power Supply with a Voltage Control input may be obtained by adapting a standard fixed-voltage SMPS. Most SMPS have a feedback loop stabilizing their output voltage, usually through a resistor dividing network located between the output and ground. A control over the output voltage may be obtained by replacing one of the resistors of this dividing network by a circuit or component having an externally controlled resistance, such as for example:

A transistor controlled by an external voltage applied at its base;

An op-amp controlled by an external offset voltage applied at one of its inputs;

A digitally-controlled potentiometer IC controlled by 1 to 4 digital control lines, depending on the type of IC (e.g. Analog Devices AD5227, Dallas DS 1804 or Catalyst CAT-5111).

Voltage Sensing approach to Power supply control:

The FIG. 5 illustrates a voltage sensing approach to self-calibrate the required Vsupply for a current regulated LED string or chain of the present invention. In accordance with this approach one installs across the Current Regulator 10, a suitable Voltage Sensor 12. The Voltage Sensor 12 may be configured in any suitable (known) manner to send a voltage signal to the control system 14 which may in turn be configured in any suitable (known) manner to send, as necessary, a voltage control signal to the fixed voltage power supply 16 which may also be configured in any suitable (known) manner to adjust (i.e. to reset), in response to said voltage control signal, Vsupply until the Voltage Sensor 12 measures a predetermined Vreg_min. This ensures that the voltage across the LED chain is just high enough to maintain the specified chain current Ireg, but no higher:

This voltage sensing approach may be extended to an LED electric circuit assembly comprising two or more current regulated LED strings or chains (see FIG. 6). However, in order to favour that the specified chain current Ireg is attained in all LED strings or chains, an individual Voltage Sensor across the Current Regulator of each LED string or chain in the LED assembly may be required (see FIG. 6). This may be achieved by either using:

A Control System with multiple voltage sensor inputs (such as a microcontroller with a multi-input Analog-to-Digital Converter, e.g. Freescale MC9S08GB60 with 8 ADC inputs, or Microchip PIC18F8722 with 16 ADC inputs).

An analog multiplexer to select one input among all those available and feed it to the Voltage Sensor input of the Control System (e.g. by cascading a number of generic CMOS analog multiplexer IC CD4051 with 8 channels, or Maxim IC DG406 with 16 channels).

A combination of the above two methods.

Control System Algorithm for voltage sensing approach:

The Control System 20 shown in FIG. 6 must be able to provide a voltage control signal to the power supply 22 which in response thereto is able to set Vsupply high enough so that the smallest Vreg measured in any LED chain is >=Vreg_min. A typical algorithm which may be used to prepare a program for a control computer device which may be part of Control System 20 is given in FIG. 7; i.e. the computer may use an iterative technique analogous to that referred to herein for a current sampling technique for the current-sensing Control System.

Since a typical LED Lighting device or system has a large number of LED chains (e.g. typically 48 LED strings or chains), this voltage-sensing self-calibration approach can imply a significant added circuit complexity and cost because of the multiple ADC channels and/or analog multiplexer ICs required. A second, more cost-effective, method based on current-sensing is presented below.

Current Sensing approach:

The FIG. 8 illustrates an advantageous voltage control (self-calibrating) approach, based on current sensing. In this circuit, the global current flowing through the LED electric circuit assembly is measured by a Current Sensor 30 placed in series with the fixed voltage Power Supply 36, either on the positive or the negative lines (for the LED electric circuit assembly shown, m as seen in FIG. 3 is equal to 1). In the implementation shown here, a Current Sensor 30 on the positive line is shown. Such a high-side Current Sensor is readily available as a standard IC component (e.g. Maxim MAX7143 or Zetex ZXCT1009). The current sensor 30 may be chosen on that basis that it is able to convert the current flowing through it into a voltage output signal proportional to the current. This voltage output signal can easily be measured in the Control System 40 through an analog-to-digital converter (ADC); the Control system may be configures to then be able to develop in response thereto a voltage control signal for transmission to the power supply 36 which can thereby be induced to reset the supply voltage.

In order to understand one manner of implementing this current sensing approach, it is necessary to examine the behavior of the LED string or chain current (Iled) as a function of the supply voltage (Vsupply). The FIG. 9 illustrates the measured current curve for a typical LED chain consisting of 10 hi-brightness Amber LEDs:

It can be seen that the current curve as shown in FIG. 9 has two main behavior modes:

A high-slope region where the current increases quickly as Vsupply increases; this behavior is maintained until Iled reaches the current limit value Ireg at which the Current Regulator circuit is set.

A low-slope region where the current stabilizes, barely increasing even as Vsupply keeps increasing; this behavior is explained by the fact that the Current Regulator circuit has started functioning, absorbing most of the Vsupply increase so that Iled and Vchain remain more or less constant.

The optimal Vsupply is attained when Iled just reaches the specified current limit Ireg; this is achieved at the “inflexion voltage” Vinfl which corresponds to the delimitation between the two regions of the current curve.

The current curve slopes “Sₕᵢ” and “Sₗₒ” for each region (calculated as dI/dV) are fairly constant; they are essentially determined by the Current Regulator circuit, and are quite insensitive to the LED characteristics. They are also very distinct, as can be seen in the above typical example where we obtain:
Sₕᵢ=5.7 mA/V 1.
Sₗₒ=0.7 mA/V 2.

It is therefore relatively easy for the Control System to distinguish between the two regions, and find the optimal Vsupply=Vinfl. One possible technique is to compare the measured slope dI/dV with the average slope “Smid”:
S_{mid}=(Sₕᵢ+Sₗₒ)/2=3.2 mA/V in our example 1.

In practice an LED Lighting system, in accordance with the present invention, as shown in FIG. 10 may have a large number of current regulated LED strings or chains (i.e. for the LED electric circuit assembly shown, m as seen in FIG. 3 equals 2 or more). In this circuit, as in the case of the circuit shown in FIG. 8 the global current flowing through the LED electric circuit assembly is measured by the Current Sensor 30 placed in series with the fixed voltage Power Supply 36; as for the system shown in FIG. 8 the current sensor 30 is able to deliver an appropriate signal to the control system 40 which in turn is able to deliver an appropriate voltage control signal to the fixed voltage power supply 36 which can thereby be induced to reset the supply voltage. The advantage of the above current-sensing approach is that it will work effectively by monitoring the overall lamp current Iarray (representing the sum of individual Iled for each of the Led chains), thereby requiring only a single sensing circuit:

Since each LED string chain can have a different individual inflexion voltage Vinfl, the overall lamp current curve will have a less-pronounced inflexion point; the inflexion zone of the lamp current curve will instead be spread over a region which may span a few volts. However, it is still relatively easy for the Control System to find the upper edge of the inflexion zone, thereby ensuring that all LED strings chains are driven at the specified current Ireg.

One possible simple measurement technique would be to find the mid-point of the inflexion zone “Vinfl_mid” and set Vsupply at a fixed voltage “Vsafe” above this value:
Vsupply=V_{infl}_mid+Vsafe

Control System Algorithm : using an incremental slope sampling based on FIG. 9

The flowchart in FIG. 11 illustrates an example of a self-calibrating algorithm (incorporating the iterative technique referred to above) for a current sampling technique for the current-sensing Control System, i.e. for the preparation of a suitable computer program using a predetermined current to voltage ratio (e.g. S_{mid}) mentioned above as a reference value in the determination of the voltage control signal to send to the power supply.

Control System Algorithm: exploiting a direct intersection calculation based on FIG. 12

The control system can use another algorithm (see FIG. 13) requiring fewer steps to determine the optimal Vsupply, In this algorithm, which may be called “direct intersection calculation”, it is possible to determine with just two measurement points each the low slope and high slope Current vs Voltage lines of the two current regions described above, and calculate their intersection point “Vinter” which will provide a good approximation to the optimal Vsupply (see FIG. 12). While the result may be less precise than with the previous algorithm, it may be entirely sufficient to achieve the desired goal of optimizing energy efficiency.

For the direct intersection calculation the two measurement voltages for each region are fixed, chosen far enough from the inflexion zone to ensure that they will be representative of the region's slope. In our example, if we know by experience that the inflexion point voltage varies at most between 21V and 27V, we can choose:

High-slope Region: Vl1=20V, Vl2=21V, leading to measured currents Il1 and Il2

Low-slope Region: Vh1=27V, Vh2=28V, leading to measured currents Ih1 and Ih2

From these measurements, one can calculate with simple linear algebra the slope of each region's Current vs Voltage line:

High-slope line:

$$Ihi ( V ) = Shi \times V + [ Ih 1 - Shi \times Vh 1 ] where Shi = \frac{Ih 2 - Ih 1}{Vh 2 - Vh 1}$$

$$Ilo ( V ) = Slo \times V + [ Il 1 - Slo \times Vl 1 ] where Slo = \frac{Il 2 - Il 1}{Vl 2 - Vl 1}$$

Low-slope line:

The intersection point voltage “Vinter” is then found at:

$$Ilo ( Vinter ) = Ihi ( Vinter ) ⇔ Vinter = \frac{\begin{matrix}( Il 1 = Slo \times Vl 1 ) - \\ ( Ih 1 - Shi \times Vh 1 )\end{matrix}}{Shi - Slo}$$

The flowchart in FIG. 13 illustrates another example of (self-calibrating) algorithm using the above “Direct Intersection” technique for a current-sensing Control System i.e. for the preparation of a suitable computer program in the determination of the voltage control signal to send to the power supply.

Once a system in accordance with the present invention has calibrated itself (e.g. at boot), the main factor expected to have an impact on Vsupply is the ambient temperature (which affects LED forward junction voltage Vled). Since ambient temperature will normally vary quite slowly during the day, a typical sampling interval “ts” would be of the order of 1 hour.

For autonomous LED luminaries comprising its own power supply and own voltage control system, the self-calibration operation may be automatically triggered at predetermined interval “ts”.

In cases where the LED lighting device or system is linked to a communication network (such as for Dellux ITL luminaries, Quebec Canada), the self-calibration operation may be triggered through an external command sent over the communication network.

During the self-calibration process, a slight variation of the LED lighting device or system light output may occur as Vsupply is varied by the algorithm. Normally this variation will be quite small, and the calibration process will be quite fast (typically under 1 second); therefore the perceived visual disturbance should be negligible.

In the case of an array of LED luminaries linked through a communication network (such as for Dellux ITL systems, Quebec Canada), this perceived visual disturbance can be further reduced by staggering the self-calibration operation within groups of luminaries, leaving a fixed delay (for example 30 seconds) between each one. In this way there will never be more than a single lighting device or system performing a self-calibration within the field of view.

In order to estimate the power gain obtained with the proposed invention, take the case of the above-mentioned typical LED Lighting device or system with 48 chains each consisting of 10 hi-brightness Amber LEDs, with a chain current Ireg=20 mA (see FIG. 10):

Vchain can vary between 18V and 26V, with an average value of 22V. Therefore to cover all cases, a design without self-calibration must use:
Vsupply=Vchain_max+Vreg_min=26V+1V=27V

The power dissipation (excluding the Power Supply inefficiency) for this LED Lighting device or system will be:
Plamp=Vsupply×Nchains×Ireg=27480.020=25.9 W

Assuming that the current-sensing self-calibrating Control System finds the supply voltage Vinfl_mid corresponding to the average actual LED chain voltage:
Vinfl_mid=Vchain_{—}av+Vreg=22V+1V=23V

A safe voltage margin may be established as Vsafe=1V. The final supply voltage set by the system is therefore:
Vsupply=Vinfl_mid+Vsafe=23V+1V=24V

The power dissipation (excluding the Power Supply inefficiency) for our self-calibrating LED Lighting device or system will be:
Plamp=Vsupply×Nchains×Ireg=24×48×0.020=23.0 W

The exploitation of the present invention may therefore result in a power saving of 2.9 W (or 12%) for our typical LED Lighting device or system, while allowing a similar reduction of its heatsink size.

An electric power system comprising a voltage controllable power supply element and a voltage control element (having the characteristics as described herein) may be extended to control a LED lighting system comprising an array of multiple LED luminaries as shown in FIG. 14. In such a system, each luminaire may be composed of one or more Current-regulated LED chains of one or more LEDs, with a Current sensor 30 measuring the total current flowing into the respective luminaire from the power supply component 46; i.e. one luminaire is shown in exploded view equivalent to the electric structure shown in FIG. 10 while one LED string is shown in exploded view equivalent to the structure shown in FIG. 4. The signals from these Current sensors may be transmitted to a Voltage Control component 50, through communications links such as:

Dedicated wired links
Wireless links (with protocols such as Zigbee, Wi-Fi, . . . )
Current carrier links on the power supply lines through power line modems

The Voltage control component 50 may be configured to use algorithms analogous to those described above to generate a Voltage Control signal fed to a voltage-controllable power supply component, through a wired or wireless voltage control communication link.

In a variation of this system, the same Voltage Control component can feed individual voltage control signals to an individual voltage-controllable power supply component inside each LED luminaire.

What is claimed is:

1. A luminaire comprising an electric circuit element for a lighting system, said electric circuit element comprising an LED electric circuit assembly, said LED electric circuit assembly comprising one or more current regulated LED chains, and wherein each of said LED chains comprises a respective current regulator and one or more LEDs linked in series with said respective current regulator, said LED electric circuit assembly being configured such that when said LED electric circuit assembly comprises two or more LED chains, said two or more LED chains are linked in parallel.

2. A luminaire as defined in claim 1 wherein said electric circuit element further comprises an electrical power component sensor means, said electrical power component sensor means being configured to generate a power component signal indicative of an electrical power component supplied to said electric circuit element.

3. A luminaire as defined in claim 1, said luminaire further comprising a voltage controllable power supply element for energizing said LED electric circuit assembly, said power supply element being configured to provide a set voltage across said electric circuit element, said set voltage being variable in response to a voltage control signal.

4. A luminaire as defined in claim 3 wherein said electric circuit element further comprises an electrical power component sensor means, said electrical power component sensor means being configured to generate a power component signal indicative of an electrical power component supplied to said electric circuit element by said voltage controllable power supply element.

5. A luminaire as defined in claim 4 further comprising a voltage control element having an input for receiving said power component signal indicative of an electrical power component supplied to said electric circuit element by said voltage controllable power supply element, and said voltage control element being configured to generate, in response to said power component signal, a voltage control signal for delivery to said controllable power supply element.

6. A luminaire as defined in claim 5 wherein said power component signal is a signal indicative of an electric current, wherein said electric circuit element comprises a current sensor, wherein said current sensor is linked in series with said LED circuit assembly, and wherein said current sensor is configured to generate said signal indicative of an electric current.

7. A luminaire as defined in claim 5 wherein said power component signal is a signal indicative of an electric voltage, wherein said electric circuit element comprises a voltage sensor, wherein said voltage sensor is linked in parallel with said current regulator, and wherein voltage sensor is configured to generate said signal indicative of an electric voltage.

8. An electric power system for manipulating the electrical power or energy provided by a power supply to an electric circuit element for a lighting system, said electric circuit element comprising an LED electric circuit assembly, said LED electric circuit assembly comprising one or more LED chains, and wherein each of said LED chains comprises a current regulator and one or more LEDs linked in series with said current regulator, said LED electric circuit assembly being configured such that when said LED electric circuit assembly comprises two or more LED chains, said two or more LED chains are linked in parallel,
said electric power system comprising:
a voltage controllable power supply element for energizing said LED electric circuit assembly, said power supply being configured to provide a set voltage across said electric circuit element, said set voltage being variable in response to a voltage control signal, and
a voltage control element having an input for receiving a power component signal indicative of an electrical power component supplied to said electric circuit element by said voltage controllable power supply element, and said voltage control element being configured to generate, in response to said power component signal, a voltage control signal for delivery to said controllable power supply element.

9. An electric power system as defined in claim 8 wherein said electrical power component signal comprises a signal indicative of the electric current supplied to said electric circuit element by said voltage controllable power supply element, and said voltage control element is configured to generate, in response to said signal indicative of the electric current supplied to said electric circuit element, a voltage control signal for delivery to said voltage controllable power supply element.

10. An electric power system as defined in claim 9 wherein said electrical power component signal comprises a signal indicative of the electric voltage supplied to the current regulator of an LED string or chain of said LED circuit assembly by said voltage controllable power supply element, and said voltage control element is configured to generate, in response to said signal indicative of the electric voltage supplied to the current regulator of an LED string or chain of said LED circuit assembly, a voltage control signal for delivery to said voltage controllable power supply element.

11. A lighting system comprising:
a voltage control component,
an LED component, and
a voltage controllable power supply component for energizing said LED component,
wherein said LED component comprises one or more luminaries,
wherein each of said luminaires comprises a respective electric circuit element and a respective current sensor,
wherein each of said respective electric circuit elements comprises a respective LED electric circuit assembly
wherein each of said respective LED electric circuit assemblies comprises one or more current regulated LED chains, each of said LED chains comprising a respective current regulator and one or more LEDs linked in series with said respective current regulator, and each of said respective LED electric circuit assemblies being configured such that when a respective LED electric circuit assembly comprises two or more LED chains, said two or more LED strings or chains are linked in parallel,
wherein each of said respective current sensors is linked in series to a respective LED electric circuit assembly, each of said respective current sensors being configured to generate a respective current signal indicative of the current supplied to a respective LED electric circuit assembly,
wherein said voltage controllable power supply component is configured to provide a set voltage across each of said electric circuit elements, said set voltage being variable in response to a respective voltage control signal, and
wherein said voltage control component having an input for receiving each of said respective current signals provided from said respective current sensor elements, said voltage control component being configured to generate said respective voltage control signals in response to said respective current signals for delivery to said controllable power supply component.
